(19) United States
(12) Patent Application Publication
(10) Pub. No.: US 2012/0231773 A1
(43) Pub. Date: Sep. 13, 2012

(54) CUBOID-BASED SYSTEMS AND METHODS FOR SAFE MOBILE TEXTING.

(76) Inventor: Gerald John(Jack) Lipovski, Austin, TX (US)

(21) Appl. No.: 13/478,354

(22) Filed: May 23, 2012

Related U.S. Application Data
(63) Continuation-in-part of application No. 13/025,017, filed on Feb. 10, 2011.
Application No. 13/025,017 is a continuation-in-part of application No. 12/943,121, filed on Nov. 10, 2010, now Pat. No. 8,014,795.
Application No. 12/943,121 is a continuation-in-part of application No. 12/785,449, filed on May 22, 2010, now Pat. No. 7,856,203.
Application No. 12/785,449 is a continuation-in-part of application No. 11/865,810, filed on Oct. 2, 2007, now Pat. No. 8,200,249.
Application No. 11/865,810 is a continuation-in-part of application No. 11/511,723, filed on Aug. 29, 2006, now Pat. No. 7,363,042.
Application No. 11/511,723 is a continuation of application No. 10/687,024, filed on Oct. 16, 2003, now Pat. No. 7,142,877.
Application No. 10/687,024 is a continuation of application No. 09/384,723, filed on Aug. 27, 1999, now Pat. No. 6,675,002.

(51) Int. Cl. H04W 4/04; H04W 4/12

(52) U.S. Cl. 455/414.1; 455/456.4

(57) ABSTRACT

Systems are disclosed for enabling, disabling or restoring cellPhone operations when these cellPhones are in certain zones. A zone is comprised of cuboids (boxes). Entering or exiting such a zone can disable, enable or restore certain cellPhone operations. A first Global Position Satellite-based system determines if a cellPhone is entering a certain geographical zone. For instance, when it enters, dialing can be disabled. A second GPSS-like system using an ultrasonic signal determines if the cellPhone is in a zone in a moving vehicle. Such a zone might be the space around the driver. A third system uses table-lookup in a system like the second system to determine if the cellPhone is in the zone that the driver is in. In mobile vehicles, the two last-mentioned systems can prevent drivers from texting when the vehicle is in motion.

### CROSS REFERENCE TO RELATED APPLICATIONS

This application is a continuation-in-part of application Ser. No. 13/025,017, filed Feb. 11, 2011, which is a continuation-in-part of application Ser. No. 12/943,121, filed Nov. 10, 2010, now U.S. Pat. No. 8,014,795 (the '795), which is a continuation-in-part of application Ser. No. 12/785,449, filed May 22, 2010, now U.S. Pat. No. 7,856,203 (the '203), which is a continuation-in-part of application Ser. No. 11/865,810, filed Oct. 2, 2007, which is a continuation-in-part of application Ser. No. 11/511,723, filed Aug. 29, 2006, now U.S. Pat. No. 7,363,042, which is a continuation of application Ser. No. 10/687,024, filed Oct. 16, 2003 now U.S. Pat. No. 7,142,877, which is a continuation of application Ser. No. 09/384,723, filed Aug. 27, 1999 now U.S. Pat. No. 6,675,002. This application also claims benefit of U.S. Provisional Application No. 60/936,605, filed Jun. 21, 2007. These applications and patents are incorporated herein by reference.

### FIELD OF THE DISCLOSED ENABLING AND DISABLING SYSTEM

In this disclosure, the word “cellPhone” designates a wireless mobile device capable of distracting a mobile vehicle driver, or other user similar to the aforementioned driver, including but not limited to a simple cellular telephone, a smart phone, an iPad, an electronic game, or a business-oriented electronic device for storing and editing textural data. This invention introduces solutions for two similar problems; (a) the disabling of certain cellPhone operations in certain zones such as auditoriums, herein referred to as the courteousCellPhone problem, whose solutions are courteousCellPhone systems, and (b) the disabling of modules used in texting in mobile vehicles, herein referred to as the safeMobileTexting problem, and whose solutions are called safeMobileTexting systems. CellPhone systems designates systems solving both problems. This application develops several safeMobileTexting systems and courteousCellPhone systems.

### DESCRIPTION OF THE PRIOR ART

As cellPhone use has rapidly expanded, discourteous and dangerous misuse of cellPhones has spurred the development of techniques to disable some cellPhone functionality, such as ringing or typing, in certain zones, such as auditoriums. This is implemented by a data structure stored in read-only memory, or stored in volatile memory which is maintained and updated by a cellPhone service provider. Present courteousCellPhone and safeMobileTexting systems try to deter users, such as teenagers, by indirect control, such as reporting instances of teenager's noncompliance to their parents. Hardware cellPhone systems might try to jam the cellPhone, which is illegal. Improved systems broadcast a signal throughout a region where operations should be disabled, but fluctuation of the signal level results in erratic behavior; a cellPhone located near the periphery of the aforementioned region will sometimes uncontrollably enable and disable the operation repetitively, depending on varying signal strength.

A safeMobileTexting system disables only a driver's cellPhone's module (such as a keyboard) used in mobile texting. Passenger's cellPhones should not be disabled when the driver's cellPhones are thus disabled. Presently, several systems disable any cellPhone that is mobile at a speed greater than some predetermined limit, whether or not the cellPhone is a driver's or a passenger's cellPhone, to the chagrin of bus riders, subway commuters, train passengers, airplane passengers and so on. In order to disable only the driver's cellPhone, and not the passenger's cellPhone, the driver's cellPhone location has to be determined. If the cellPhone is found to be located near the driver's controls (such as vehicle's steering wheel, gas pedal, brake) that cellPhone is assumed to be the driver's cellPhone. The driver's cellPhone's keyboard (or other modules used in texting) can be disabled to prevent the driver from texting, while the passengers leave their keyboards (and other modules) enabled so they can phone, text or play games. Applicant's prior art (U.S. Pat. No. 7,856,203 and application Ser. No. 11/865,810) already shows two systems that disable a cellPhone's module when the cellPhone is close to the driver. Presently, a Wall Street Journal article (Feb. 25, 2012) covered work done by Dr. YingYing Chen at Stevens Institute of Technology to locate the driver's cellPhone in a mobile vehicle, which is the key step in developing a safeMobileTexting system.

### SUMMARY OF THE INVENTION

This application's inventive system enables, disables or restores a mobile vehicle driver's cellPhone's operations in certain zones to disable texting while driving. In a first embodiment a subsystem, measuring the transient delay of three ultrasonic signals, uses trilateration to locate any cellPhone within the vehicle. In a second embodiment, a subsystem using a 3-d matrix, stores “1” in the matrix where texting is enabled, or “0” where it is disabled. The transmission delays are used as matrix indexes to look up the matrix element associated with the cellPhone's location to determine if texting at that site is permitted or not. A third embodiment is a subsystem that uses a single common GPS receiver used in two modes: to obtain the xyzCoordinate in space, of the mobile vehicle using rf signals, or alternatively: to obtain the xyzCoordinate of the driver's cellPhone within the mobile vehicle using ultrasonic signals. Examples of the use of these systems are briefly described.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures of which like reference numerals identify like elements, and in which:

FIG. 1 is a block diagram of relevant modules of a courteousCellPhone system constructed in accordance with this disclosure.

FIG. 2 is a block diagram of a courteousCellPhone system incorporating a GPS receiver in communication with four GPS satellites, constructed in accordance with the courteousCellPhone system of FIG. 1.

FIG. 3 is a block diagram of relevant modules of a safeMobileTexting system for use in locations where a cellPhone's modules should be enabled or disabled based on their location within a mobile vehicle, constructed in accordance with this disclosure.

FIG. 4 is a block diagram of a safeMobileTexting system incorporating at least four ultrasonic signal transmitters in communication with an ultrasonic signal receiver disposed within a cellPhone, constructed in accordance with the safeMobileTexting system of FIG. 3.

FIG. 5 is a top view of a ladder laying on the floor, upon which a bus's transmitters can be located.

FIG. 6 is a pseudo-code description of a storage structure to describe a cuboid.

FIG. 7 is a pseudo-code description of a storage structure to describe a zone.

FIG. 8 is a three-dimension diagram of cuboids having cuboids within them.

FIG. 9 is a pseudo-code description of a program segment to describe the testing of a cuboid's data against the cellPhone's location.

FIG. 10 shows variables utilized in the virtual memory subsystem.

FIG. 11 is a roadmap describing an intersection with a left turn lane.

### DESCRIPTION OF A PREFERRED EMBODIMENT

A GPSS Coordinate Module Using Trilateration

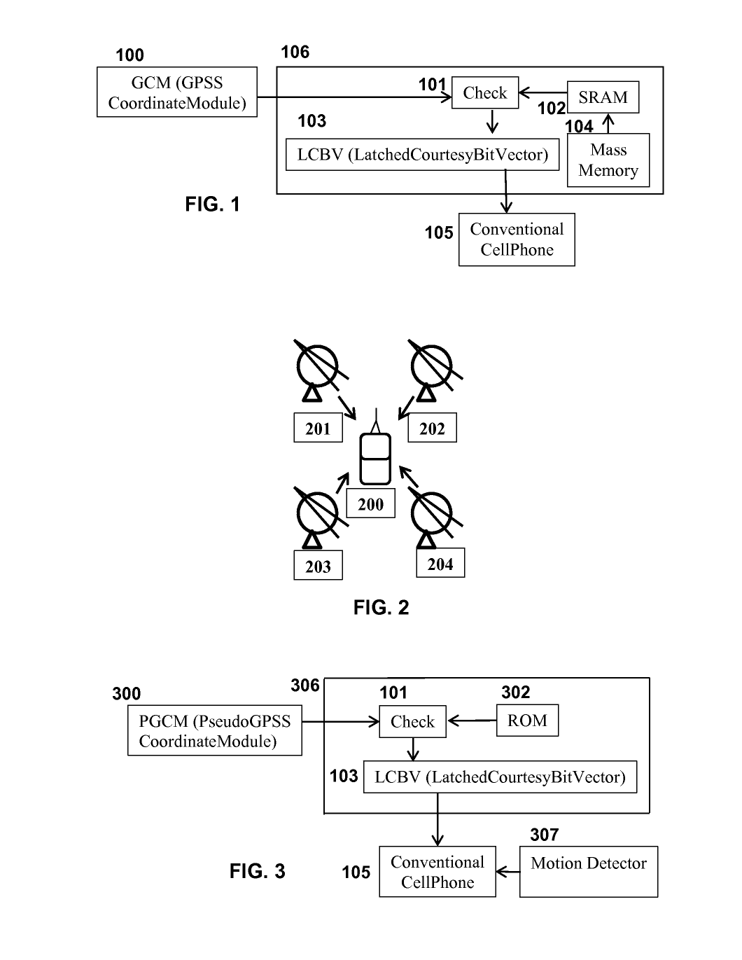

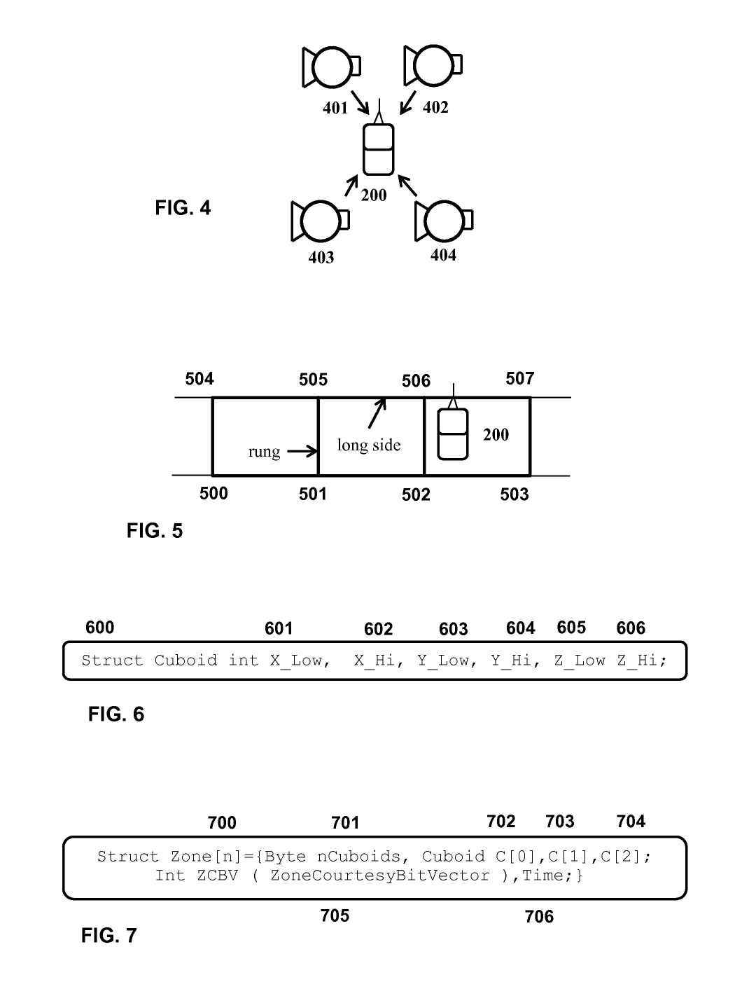

FIG. 1 shows the block diagram of modules in a courteousCellPhone system constructed in accordance with this disclosure, which includes a widely used GPSS Coordinate Module GCM 100. A proximity detector 106 is the subsystem comprised of modules 101, 102, 103 and 104. FIG. 2 illustrates external connections to a cellPhone comprised of at least three radio-frequency signal transmitters 201, 202 and 203, and possibly a spare transmitter 204, selected from a pool of 24 transmitters orbiting in space, and transmit to radio-frequency signal receivers incorporated in each cellPhone 200. The signals sent by the aforementioned transmitters are received in the GCM 100. The Wide Area Augmentation System (WAAS) is a refinement of GPS that is capable of an accuracy of about one meter.

The operation of the cellPhone's GCM 100 is mainly the well-known trilateration evaluation that is briefly described herein: Assume a first transmitter is at location (0,0,0), a second transmitter is at location (0,0,h), and third transmitter is at location (0,i,j). Assume a receiver is found to be at distances d1, d2, d3 from these three transmitters. The desired cellPhone's location in free space is at coordinates x, y and z, where distances from transmitters to the cellPhone d1, d2 and d3, satisfy equations for spheres laid out at centers' offsets h, i, and j: d1²=x²+y²+z², d2²=(x−h)²+y²+z², d3²=(x−i)²+(y−j)²+z². Trilateration evaluation is given distances d1, d2, and d3, and it solves for and outputs x, y, and z.

### Ultrasonic Transmitter Placement

FIG. 3 shows a block diagram of modules in a safeMobileTexting system derived from the well-known GPSS module discussed in the previous paragraph. The safeMobileTexting system is almost the same as the GPSS cellPhone system, but not exactly because ultrasonic signals are used instead of rf signals; hence the prefix “pseudo”. A proximity detector 306 is the subsystem comprised of modules 101, 302 and 103. An ultrasonic pulse is generated by an ultrasonic signal transmitter such as an extended-range speaker or a transducer, and received by a signal receiver, such as an extended-range microphone, extended-range mouthpiece, or a transducer. When an ultrasonic signal is modulated with a random signal, a “hush” may be heard from the transmitter. This sound can manually alert the user to disable/enable his/her cellPhone.

The three transmitters 401, 402 and 403, and possibly a fourth transmitter 404, can be disposed in three or four of the mobile vehicle's locations within its interior space. For some predetermined period p and time t, transmitter 401 pulses at time t, transmitter 402 pulses at time t+p, transmitter 403 pulses at time t+2*p, transmitter 404, if a fourth transmitter is used, pulses at time t+3*p, and next 401 pulses again after another p, repetitively, forever. The pulse from one transmitter, say 401, is wider than the other three pulses, to mark the beginning of sending a zone's data. All four pulses are thus transmitted non-overlapping and are received by the same cellPhone 200, to obtain four transmission delay values. Other pulse signal shapes could be used to broadcast information or control bits from transmitter to cellPhone (not shown).

Some cellPhones may use a headset comprising a mouthpiece and earphone rigidly joined together, both coupled to the cellPhone by wires. If the driver's mouthpiece is to be disabled when it is within reach of the driver, the mouthpiece signal can be repeatedly examined like the cellPhone microphone signal was examined. If the mouthpiece is found to be within the reach of the driver, the mouthpiece input can be disabled at the cellPhone end of the aforementioned wire. If either the mouthpiece or earphone needed to be disabled, and if the mouthpiece is found to be within a short distance from the reach of the driver, the mouthpiece and earphone can be disabled together.

Although the specification's mobile vehicle will be more commonly a medium-size automobile, the medium-size automobile is a special case of the more general bus vehicle. A mass-transit mobile vehicle like a bus can use a ladder organization of courtesy signal transmitters to determine the delay from each courtesy signal transmitter to each cellPhone, and thus determine the location of the cellPhone within the contiguous space of the aforementioned mobile vehicle.

To illustrate this organization and its operation, imagine (FIG. 5) a horizontal ladder organization having eight courtesy signal transmitters, one at either end of four rungs, such intersections are numbered in order 500, 501, 502, 503, along the bottom side running left to right and, and numbered 504, 505, 506, 507 on the top side, running left to right, and there are rungs: (500 to 504), (501 to 505), (502 to 506) and (503 to 507). If the vehicle has a transmitter near the driver steering wheel, the vehicle will be the one numbered as 500. A receiver 200 in the cellPhone receives ultrasonic pulses from these ultrasonic transmitters.

Transmitters 500 to 507 send pulses in time in the same order as their numbers increase. Transmitter 500, sent first, sends a signal whose pulse width is wider than the other transmitter's widths. The cellPhone receives this signal and computes the time of the rise and fall of this signal to obtain the delay to the cellPhone from the transmitter numbered 500, as well as its pulse width. Transmitter 501's pulse width is shorter than transmitter 500's pulse width, so its arrival terminates the search for the longer pulse. Transmitter 501's delay to the cellPhone is similarly stored in the cellPhone's memory. Likewise, transmitters numbered 502 to 507 each send pulses, one after the other, whose widths are about the same as transmitter 501's pulse width. If needed, the number of transmitters can be increased, and appended to the right of the ladder. These delay values are input to the cellPhone and now are just stored in its memory.

The cellPhone's microcontroller takes saved delay values three at a time to put the aforementioned delay values into a trilateration evaluator that computes the xyzCoordinate of the cellPhone, as discussed earlier. First, delay values from transmitter 500, transmitter 501 and transmitter 504 are read from memory and input into the trilateration evaluator to get a first xyzCoordinate, which is saved in memory. Next, delay values derived from evaluating transmitter triplets (500, 501 and 505), (501, 502 and 506), (501, 502 and 505), (501, 502 and 506), (502, 503 and 506) and (502, 503, 507) are saved in cellPhone memory. If one of the transmitter's signal yields bad data, perhaps becoming overloaded with ultrasonic noise, the triplet, that use that transmitter's signal, will be ignored. Based on measurements of errors for each of the six xyzCoordinates, the xyzCoordinate from these evaluations having the least expected error will be used. The cellPhone system should be able to get at least three valid delay values in spite of any one transmitter signal being blocked, jammed, or interfered with.

A medium-size automobile is treated like a short bus modeled on a ladder with rungs (502 to 506) and (503 to 507) missing. (See FIG. 5 again). A cellPhone can be located in a medium-size automobile by getting the travel delay values from the leftmost four transmitters: 500, 501, 504 and 505. The delay values are fed three at a time from cellPhone memory into the trilateration evaluator as transmitter triplets: (500, 501, 504), (500, 501, 505), (500, 504, 505) and (501, 504, 505). Each of xyzCoordinates obtained thus are stored in cellPhone memory. Selection, of which xyzCoordinate will be used subsequently, will be determined in the same manner as was discussed above for the long narrow buses.

A long thin bus or medium-size automobile having transmitters only at 500, 501, 505 and 504, could have some difficulty discerning distances from transmitters at 503 to receivers at cellPhone 200 at the far right of the ladder. However, if the system actually only needs to measure the distances around the driver's seat then all that is needed is the four transmitters at 500, 504, 501 and 505.

These delay values, the time for the signal to travel from transmitter to receiver, are converted to distances by multiplying this delay value by the speed of the signal. These distances are input to an aforementioned trilateration evaluator, which outputs the cellPhone's xyzCoordinates relative to its ultrasonic signal transmitters. These xyzCoordinates are sent to the Check module 301, which determines which zone the cellPhone is in, if any.

Zones, Data structures, and Operations Done on Them.

The present application aims to prevent the mobile vehicle driver's texting while driving, but not disabling passenger cellPhones in any way. This is achieved by means of zones, which are now discussed.

Data structures herein specify how a (rectangular) cuboid is described, and specify how a zone is stored in memories SRAM 102 or ROM 302. FIG. 6 shows a pseudo-code description of a (rectangular) cuboid 600 which is a “cube” whose opposing sides are parallel, and whose corners are right angles; they are described by xyzCoordinates: X.Low 601 giving the lowest value of the x coordinate, X.Hi 602 giving the highest value of the x coordinate, Y.Low 603 giving the lowest value of the y coordinate, Y.Hi 604 giving the highest value of the y coordinate, Z.Low 605 giving the lowest value of the z coordinate, and Z.Hi 606 giving the highest value of the z coordinate. An example of a cuboid would be a shoebox.

FIG. 7 shows a pseudo-code description of a zone structure. The description of a zone 700 is comprised of a description of each cuboid in it. For instance, the particular zone 700 might have first the number of cuboids nCubes 701, followed by n of the cuboids [0 to nCuboids−1]. Each cuboid herein is configured according to FIG. 6. Cuboid data 702 could be stored and read out first, cuboid data 703 could be stored and output next and the cuboid data 704 could be stored and read out last in consecutive locations in the SRAM 102 or ROM 302. Following that cuboid data would be the ZoneCourtesyBitVector (ZCBV) 705 specifying what parts of the conventional cellPhone are to be disabled or enabled, and Time (706), the time in which this zone operates on the conventional cellPhone wireless mobile device 103. Other zone fields, such as pointers, needed to speed up the search for a zone or pointers needed for data garbage collection, can be included in this specification, but are not shown in FIG. 6. Although the zone illustrated in this specification has three cuboids, a zone might have any number of cuboids.

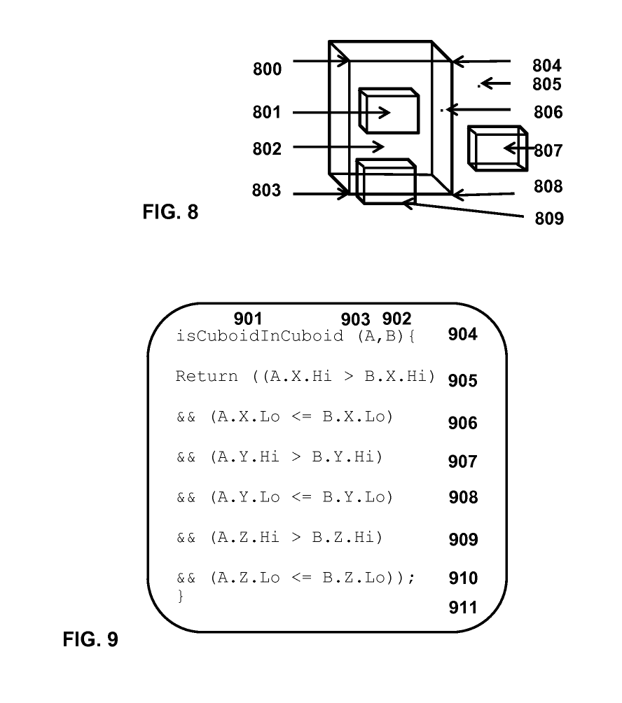

FIG. 8 illustrates some terminology regarding cuboids in 3-D space. A cuboid 802 comprises a front surface with corners 800, 803, 808, 804, a back surface having an identical set of corners (not numbered herein) and all points between them. Point 806 is in cuboid 802, and point 805 is outside cuboid 802. The cuboid 801 is included in the aforementioned cuboid 802, cuboid 807 is excluded from cuboid 802 and cuboid 809 is partially included in cuboid 802 because some points in cuboid 809 are in cuboid 802 and some points are not.

FIG. 9 gives a procedure isCuboidInCuboid(A, B) 901, shown in the procedure's first line 904. It returns true (1) if smaller cuboid B 902 is within larger cuboid A 903. The first parameter's high x value is compared to the second parameter's high x value; if the second parameter is too large, is CuboidInCuboid returns with value 0 (false) 905. The first parameter's low x value is compared to the second parameter's low x value; if the second is too small, is CuboidInCuboid returns with value 0 (false) 906. These comparisons are similarly executed for y 907 and 908 and z 909 and 910. If all comparisons are verified true is CuboidInCuboid returns with value 1 (true) 911.

Each passenger is associated with his or her own passenger zones, each of which are where the cellPhone would be held comfortably in front of him or her while texting, talking or observing a picture or movie . . . (a zone could be a cuboid for texting, a cuboid for talking, . . . ). Each passenger's cellPhones only operates in the zone created for it, to dissuade passengers from grabbing and using some other passenger's cellPhone. Any cellPhone in the driver's zone is assumed to be a driver's cellPhone, in which, when the vehicle is in motion, its keyboard is disabled after, say, three keys on it are pressed per minute, but which can control the other cellPhones in the mobile vehicle when the vehicle is moving slower than a predetermined speed. A driver's cellPhone can communicate using channels through the service provider's cell tower, from the driver's cellPhones 500 to the other cellPhones 501, 502, 503, 504 . . . which are in the vehicle, to give commands or data to them or receive data from them.

Also, since each passenger has a microphone and a powerful microcontroller in the user's cellPhone, the cellPhone can monitor the loudness of the passenger, automatically disabling some module in the passenger's cellPhone if the passenger makes too much noise. Microcontroller-based signal analysis can be used to identify and monitor only specific passengers such as children, to avoid disabling any part of the passenger's cellPhone when an adult raises his or her voices to address a passenger. For instance, if the driver is a parent and the other cellPhones are used by children, if one child is misbehaving and makes a loud, high-pitched squeal, that child's cellPhone can be disabled, leaving the other cellPhones enabled. This should deter a misbehaving child from inappropriate activity, but not affect the behaving children.

The current cellPhone's location's xyz-coordinates are first output from PGCM 300 or GCM 100 to the check module 101. These xyzCoordinates are treated herein as a cuboid in which the highest and lowest x value are the same, the highest and lowest y value are the same and the highest and lowest z value are the same. The cuboid data stored in ROM 302 or SRAM 102 is then sent to this check module 101. The check module tests to see if the aforementioned xyzCoordinate cuboid is wholly inside the cuboid whose data are in ROM 302 or SRAM 102. By the way, such a procedure is PointInCuboid used by a game program IV: Multiplayer Wiki.

GCM 100 repetitively outputs the cellPhone location relative to the GPSS transmitters in space, and PGCM 300 repetitively outputs the cellPhone location relative to the vehicle. As these are continuously output, ROM 302 or SRAM 102 outputs zone data, and check 101 finds the first zone that the xyz-coordinates are in; based on that zone's ZCBVZoneCourtesyBitVector Bits 103, the bits in LCBV 103 are set, cleared, or restored.

Overlapping zones normally have the same value in ZCBV (ZoneCourtesyBitVector) 705, so they may be stored in any order and be read out in any order in the SRAM 102 or ROM 302. However, overlapping zones can have different ZCBV 705 values; if anywhere a zone “a” deliberately overlaps zone “b”, higher priority zone “a” should be stored in ROM at the lower address and read from ROM earlier than lower priority zone “b”. In particular, a McCarthy formalism developed for list language programming is expressed as a nested pseudo-code if-then-else expression such as: if(a) then b else if(c) then d else if(e) then f else if(g) then h else i. conditions a, c, e, g test the GPSS coordinates of the cellPhone as illustrated in the next paragraph, resulting with “1” if the coordinates are disposed within the cuboid. The expression a is evaluated to true or false. The operations b, d, f, i apply the ZCBV to the LCBV. If a is true, b is executed and none of the other tests: c, e or g are done, and none of the operations b, d or f are executed. If a is false then c is tested, and so on. The final expression i is the default operation and is executed if none of the tests a, c, e, and g, are found to be true; it is usually all 0's. For the highest priority valid test being true, the LCBV (LatchedCourtesyBitVector) 103 is modified according to the ZCBV (ZoneCourtesyBitVector) 705; in that step, a pair of bits from this row, ZoneCourtesyBitVector, will modify a single courtesy bit in the LCBV 103; if the pair is 00, no changes are made to the indicated courtesy signal, if the pair is 01, the aforementioned bit is saved and then is set, if the pair is 10, the bit is saved and then cleared, and if the pair is 11, the saved bit is restored. The check operation 101 can be implemented in software in a microcontroller or in hardware in a special-purpose module. The output of LCBV gates are hard-wired to certain cellPhone modules to enable or disable these aforementioned modules in the CellPhone. For the highest priority valid test being true, the LCBV (LatchedCourtesyBitVector) 103 is modified according to the ZCBV (ZoneCourtesyBitVector) 705.

### Second Preferred Embodiment Using a 3-D ROM Matrix

An operation based on table lookup, may be attractive for simple systems like electronic games. The three modules, ROM 302, PGCM 300 and Check 301 can together be implemented using a three-dimensional table-lookup technique. Suppose three ultrasonic signal receivers' measured delays scale into discrete addresses addressing a three-dimension memory array. This memory array element M[i],[j],[k] stores a 1 if texting is permitted in the vehicle's interior corresponding to the i,j,k element of M, and it should otherwise store a 0. The matrix should use Gray coding for addresses to the matrix to avoid changes more than one address bit whenever a matrix address changes by incrementing or decrementing it.

The aforementioned technique addresses the three-dimension array with travel delay values. Further, instead of being addressing with PGCM's delay values, the array could be addressed using PGCM's distance values or the array could be addressed with PGCM's xyzCoordinates 300. Also, the memory word width can be expanded to enable, disable or restore more cellPhone modules. In particular, the matrix elements could be xyzCoordinates. One of ordinary skill in the art can implement ROM 302 as flash, eeprom, or other memory type, and with sufficient word width. The data at each element can be multiple bit numbers, for example the xyzCoordinate of the ultrasonic receiver.

### The Third Preferred Embodiment Featuring Convertible Operations

The convertible GPS receiver, capable of locating the mobile vehicle in space, and also locating the driver in the vehicle's space, is now studied.

Compared to the safeMobileTexting ROM memory 302, the courteousCellPhone system SRAM 102 stores a small (1 k byte) working copy of a large amount of data which is stored in a mass (32 Gigabyte) flash memory in an external server 104, and brought into the cellPhone like a virtual memory system's data are loaded into a processor's cache memory.

The zone data are to be loaded into SRAM 102 in much the same as computer maps are loaded into a Garmin (or similar) GPSS receiver while the user is driving. The disclosed CourteousCellPhone system experiences similar behavior, but instead of loading streets and other topological objects displayed into the aforementioned Garmin receiver, this system loads zone descriptions into SRAM 102. The SRAM 102 can then be read out and operate on cellPhone's modules exactly like the ROM 302 is read out and operates on them.

A commercially available GPSS receiver chip, such as the MAX2769B, may already be incorporated into the cellPhone which is being upgraded into being a courteousCellPhone, for instance to accommodate apps like sat-gps-locate.com. Although the aforementioned chip does not yet have courteousCellPhone and safeMobileTexting features, those features could be added onto the chip without greatly increasing the chip's cost. Alternately, external hardware such as multiplexers can be coupled to it to provide needed functions. The resulting chip(s) may become the aforementioned GCM 100 described earlier in this specification. The reader can read this specification from its beginning, concentrating on the discussion of courteousCellPhone system following FIG. 1, to understand what is coupled to the aforementioned GPSS receiver chip. The reader can read this specification from its beginning, concentrating on the discussion of safeMobileTexting system following FIG. 3, to understand what comprises safeMobileTexting. Finally, the reader can simultaneously follow both threads of the specification up to this point, to development of a single chip, which implements both a courteousCellPhone and a safeMobileTexting system. In systems handling both problems, the system might alternate the solutions: the courteousCellPhone solution could be run, then the safeMobileTexting solution could be run, repetitively in an infinite loop.

The three methods of generating xyzCoordinates, using trilateration, table lookup, and GPS receiver with adaptation for ultrasonic signals can be simultaneously used together concurrently in the same mobile vehicle. They all use the ultrasonic signal transmitter in the same way.

### Outputting Parallel Binary Data Such as Telephone Numbers, or I/D Numbers

Instead of ZoneCourtesyBitVector (ZCBV) 705 setting, clearing, or restoring cellphone bits in LCBV (LatchedCourtesyBitVector) 103, if Check 101 outputs 1, ZCBV can be written into a parallel binary latch. One such instance of this mechanism writes ZCBV into a latch, which dials a phone number. Another instance writes ZCBV into a latch, which outputs data to be dialed when the dialed phone answers the call. Another instance writes a program's PD.
Downloading SRAM from the Server's Mass Memory to Implement a Virtual Memory.

Obviously the cellPhone can move in space. After the cellPhone moves, its new xyzCoordinates are sent to the server and stored in xyzCoordinates 1001. If the cellPhone's xyzCoordinates changes, the cellPhone's SRAM data 102 should be refilled with zone data 1000. However, if good zone data is already in the cellPhone, it should not be sent again.

To load potentially useful zone descriptions into the cellPhone memory, each zone's default cuboid are checked against the new xyzCoordinate using is PointInCuboid; if the xyzCoordinate 1001 is in the cuboid, then a packet containing the zone's data 1000 is sent to and written into SRAM 102. If the newest xyzCoordinate is found to be in, say three default cuboids, three default cuboid zone's data 1000 are downloaded into the cellPhone SRAM 102.

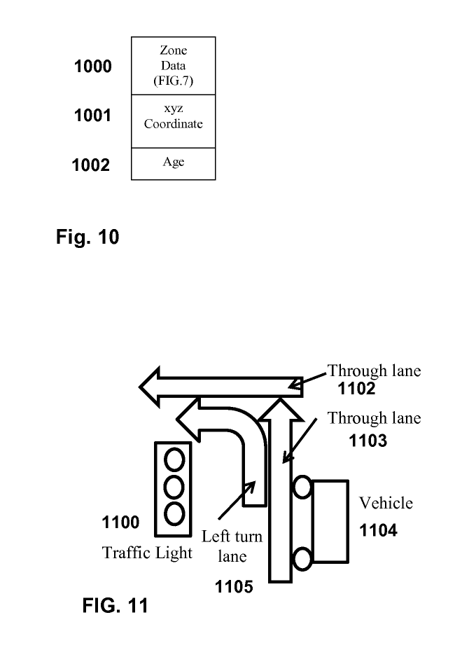

In the SRAM 102, each zone's list has a variable age 1002, which is initially cleared. (See FIG. 10.) Upon every memory operation, all ages 1002 are incremented. When memory space is needed to bring a zone from mass storage into SRAM 102, as illustrated in the previous paragraph, the list with the largest age 1002 will be replaced by the zone data that has just been brought into SRAM 102, and the age 1002 will be cleared.

The packet newly output from mass memory 104, is broadcast to all cellPhones, If the cellPhone is waiting for that particular packet, its data is simultaneously written into the aforementioned zones stored in their SRAM 102. Once thus receiving all updating zone data for an operation, the loop is repeated continually updating LCBV (LatchedCourtesyBitVector) 103 using the ZCBV (ZoneCourtesyBitVector) 705.

In an emergency, responsive zone data could be transmitted to all cellPhones in a populated sports stadium within a fixed, small number of milliseconds, independent of the number of cellPhones or users thereof. Also note that the virtual memory management is executed only when xyzCoordinates change. When xyzCoordinates don't change, the SRAM will supply zone data to 102 check 101 without using the mass memory 104 or external communication channels.

A system might be one of two data organizations. An alternative to a virtual memory could be a queue, into which zone data is pushed and pulled. Another alternative could be a circular queue.

### Parallel Servers

The system, as specified so far, tests each cellphone's xyzCoordinates against all default cuboids in the system. This system might experience an excessive workload. To handle a large workload, hash addressing can be used to “smooth out” the workload, and parallelism, MIMD (Multiple Instruction Multiple Data) or MISD (Multiple Instruction Single Data) might divide up the work of comparing each xyzCoordinate to each default cuboid. SIMD is not used in this application.

Hash addressing can distribute a load of input data to a nonempty set of processors. Suppose data is to be located at address A, but there are only, say, five processors, each having memory storing one fifth of the total data in the processor's memory. In a hash code, an address, for example, A, can be divided by five, the remainder can select which processor's memory has the data, and the quotient can be the data's local address used within the processor. Hash addressing spreads out the work so a congestion of data is usually not squeezed through one of the processor-memories, the other processor-memories doing none of the work. Using MIMD, the data can be “dealt” into each of the five processor's memories and the data can be checked against the xyzCoordinates therein simultaneously. This is five times faster than checking each unit consecutively in one processor. The output from the MIMD processor can be fed to a MISD (pipeline) processor. In a 5-unit MISD processor, each processor i feeds data to processor i+1 for i=0 to 4, and each processor searches one fifth of the cuboids. In these parallel organizations, MIMD and MISD, as the number of users increases, the number of processor-memories is made to increase proportional to that number.

The number of zones that need to be checked can be reduced by further expanding a zone's data by incorporating additional fields, such as the memory address of the next zone to the zone being processed, in each direction. The search for zones to be checked can then be limited to these aforementioned neighboring zones.

Current technology favors using really cheap (flash) memory in a MIMD organization. Each processor can be implemented with mainly two 32 gigabyte flash memory sticks coupled to a Vinculum-II Embedded Dual USB Host Controller IC. A large number of very small processors can handle the testing of all xyzCoordinates against all default cuboids.

As is well-known to a microcontroller systems designer of ordinary skill in the art, the larger memory 104 can be maintained entirely in software, rather than in hardware, especially when hardware virtual memory support is not available in the system. The cellPhone can have its own dedicated courtesy channel and courtesy server to send zone information from the server to the cellPhone, instead of using a service-provider server and communication channel, to implement the virtual memory system.

Interaction with Service Provider Access, to Enter and Check Data.

A service provider's communication channel, which sends packets of user audio, video and computational data to other users, may also send and receive data through the service provider's communication channel so that qualified users can access or modify courteousCellPhone data that is stored in mass memory 104. Mixed in with these user packets, some courteous cellPhone packets are sent to the cellPhone and some are received from the cellPhone by the abovementioned cellPhone system.

The cell tower that supports the voice, video, and user data channels to-and-from other user cellPhones, can provide the zone data to the aforementioned cellPhones' modules. The cell tower's server can set up a password-protected web page accessible to a laptop or a smart phone app, though which the service provider can choose from various environments and enter various parameters. The zone's cuboid data should be written when the environment's landowner sets up an account with a service provider. The zone's cuboid's parameters can be obtained by the service provider reading an architect's blueprint of the concert hall. Alternatively, a service provider's installation tool can be used, having a GPSS receiver, and able to communicate through the internet with the service provider's tower's server. The tool would be positioned into each corner of the hall, one corner at a time, and when the corner's GPSS location is stabilized, the corner's location is sent from the tool to the cell tower's server.

The zone's ZCBV 705 and Time 706 data might be altered on a daily basis. The aforementioned web page can provide the owner of the hall, or his/her designee, access to this data at any time. In particular, the parameters ZCBV 705 and Time 706 would be set up before the concert, and set up for the next event after the end of the concert. The owner or his/her designee could write a short program that can be loaded first thing in the morning and stepped through all the operations for the hall during the subsequent day.

### Examples of Use of the CourteousCellphone and SafeMobileTexting.

Examples are now given of possible uses of this inventive system. However a system need not consist of all of these examples of usage. Applicant intends these examples to inspire further examples of uses of the system.

A square-shaped concert hall obviously can use a courteousCellPhone having one zone, comprised with one cuboid, both coextensive with the concert hall. The concert hall happens to have two doors, each door having one zone coextensive with the door, and the concert hall has one additional small zone (the override) disposed outside the hall, each zone comprising one cuboid. Before the performance begins and while the performance is in progress, the two doors and their two zones are configured such that cellPhones entering the hall will save their enable/disable state and then disable cellPhone modules. The override can be used for restoring enable/disable states of a cellPhone user that has to leave early. At any time, if a cellPhone is within the aforementioned small override zone, its enable/disable state is restored. when the zone's timer times out, the courteousCellPhone's enable/disable state can be automatically restored. Otherwise the zone's Time can be entered, before the performance, with long enough time to complete the performance. After the conclusion of the performance, the cellPhones leaving the concert hall through either door will restore the stored enable/disable state, regardless of by which door the cellPhone entered into the hall.

The transmitters in the concert hall doorway can be ultrasonic or the description of the zones can be sent in the service-provider's channel. The ultrasonic methodology can send signals so that the transmitter generates a “shh” sound, as if some person is asking for quiet. The service-provider's channel methodology has the property that the wiring and server can be mainly on the service-provider's property where it is more secure.

In like manner, texting could be controlled in schoolrooms and other parts of the school. Consider a six classroom school building. Cellphones could be enabled when students are in the playground before school starts, but they can be disabled when students are in the hallway, filing into their classroom. Cellphones could be enabled when students are being taught how to use a cellphone, but they can be disabled when students take an exam or are in a bathroom. Video input or output might be disabled while the cellPhone is in the bathroom. Cellphone texting and video enabling could be enabled or disabled using a personal computer in the principal's office. A secure web site on that computer could give the principal's secretary control of the current and saved future enabling of the aforementioned rooms. However, changes to the schedule would be sent to a service provider to be combined with other changes, and stored in the service provider's mass memory, from whence they will be downloaded into the cellphones.

A mobile vehicle may utilize both courteousCellPhone and safeMobileTexting systems in a school zone, wherein driver's texting is prohibited, but passenger texting is enabled. The courteousCellPhone system might identify the school zone location in free space using conventional GPSS with rf signals, and, therein, safeMobileTexting using ultrasonic signals might prevent the driver's texting (even if the vehicle is halted), and might or might not enable passenger's texting, while the vehicle is in the school zone.

The combined courteousCellPhone and safeMobileTexting systems might enable a mobile vehicle's driver's texting safely while driving in a part of the turn lane, and disable texting otherwise. Consider a mobile vehicle 1104 on a north-bound through lane 1103 driving up to a traffic light 1100 on lane 1103 and turning left. On through lanes 1102, 1103, SafeMobileTexting disables driver's texting as long as the mobile vehicle is going more than a few miles per hour. The mobile vehicle enters the left turn lane 1105, which enables the driver's texting, because texting will be safe until a few seconds before the left turning signal light 1100 is about to turn green, whence courteousCellPhone disables driver's texting. The zone encompassing this left turn lane will be made using many cuboids, enough to cover all parts of the circular lane, but not enough to cover other lanes. Disabling texting, during this latter time interval, focuses the driver on carefully attending to the turn lane, and not attending to the courteousCellPhone, while leaving the intersection. Afterwards, safeMobileTexting disables driver's texting when the mobile vehicle resumes going more than a few miles per hour on through lane 1102. Each lane, 1102, 1103 and 1105, can have a separate sequence of enabling and disabling operations that reduces the number and severity of accidents but allows safe operations, especially for texting while driving. Throughout this operation, passenger's texting is not disabled.

A continual distraction for mobile vehicle drivers has been and will continue to be for the mobile vehicle driver to eat fast food while driving. Although the following proposed method does not irrefutably deter the driver from eating his or her food while driving, it complements a driver for stopping even if he or she might not actually be stopped, but by giving such a complement, the system might encourage the aforementioned driver to stop to eat. This could avoid a significant amount of distractive driving. A zone is configured to enclose the fast-food drive-through lane. Then a driver drives the mobile vehicle through the aforementioned drive-through lane, placing an order for a fast-food carryout meal. Upon the driver receiving his or her food, and consequently moving the mobile vehicle out of the aforementioned zone, a time limit is put in the mobile vehicle's cellPhone's memory. The time limit can be made longer or shorter, manually by the fast-food waitress or automatically by the apparatus used to order food items in a fast-food restaurant, to be enough for the driver to eat any meal being bought. Then if the vehicle is stopped before the aforementioned time limit, long enough for the driver to eat his or her meal, an indicator light is lit, or an email, voice mail or text message is composed, thanking the driver for stopping. If the driver actually did not eat some fast food, the driver is erroneously complemented for doing a good deed, and may gradually be encouraged to continue doing the good deed: to stopping to eat fast food while driving.

Automatically Emailing, Texting or Sending Photo/Video to or from Mobile Vehicles

Recall that parallel binary data can be sent to a courteousCellPhone. This capability might provide assistance when a mobile vehicle passes through a construction zone where men are working A courteousCellPhone zone would have been created coextensive to the construction zone. As a mobile vehicle passes into the zone, a voice mail, texting, photo or video message might be sent to alert the mobile vehicle's driver of the reduced speed limit, and caution the driver about men currently working in the zone, and other dangers. When a mobile vehicle travels on a roadway that has a history of bad accidents, voice mail could warn about dangers. In another example, the message might be a local warning for a terrorist attack and instructions sent to exit the area to make room for emergency vehicles. In another example, the message might be a sales pitch for some real estate, or some other advertisement. If all advertising were done using courteousCellPhone systems, all advertising signs could be removed from most roadways.

If warnings were done using courteousCellPhone systems, many billboard warning signs could be removed from many roadways. Note that using the courteousCellPhone is better for warnings or advertising than using a laptop computer, a 2-D bar code, a cardboard or metal sign, because people usually take their cellphone where they go, but the courteousCellPhone warning message can be timely and tailored to each cell by giving different instructions to cellPhone users in each zone.

In order to render possibly hidden cellPhones easier to identify by security personnel, a very simple rf transmitter embedded in the cellPhone might be turned on or turned off using a courtesy bit in LatchedCourtesyBitVector 103. When turned on by security personnel when they are near high-valued targets, the aforementioned transmitter can transmit a simple signal that the security personnel can easily check for. When turned off, the cellPhone's transmitter can reduce power consumption and would be harder to detect by terrorists who seek to destroy the transmitter. Further, the signal being transmitted can have at least two values: initial value and an exposed value. When the cellPhone is manufactured, the aforementioned signal is an initial value and becomes an exposed value when anyone attempts to open the cellPhone's back panel. Security personnel can respond with greater vigilance when the simple signal is an exposed value, because terrorists might have opened the back panel to change the cellPhone into a bomb.

### Outputting Parallel Binary Data.

Instead of ZoneCourtesyBitVector (ZCBV) 705 setting, clearing, or restoring cellphone bits in LCBV (LatchedCourtesyBitVector) 103, if Check 101 outputs 1, ZCBV can be written into a parallel binary latch. One such instance of this mechanism writes ZCBV into a latch, which dials a phone number. Another instance writes ZCBV into a latch, which outputs data to be dialed when the dialed phone answers the call.

These mechanisms use the aforementioned outputting parallel binary data operation in an attempt to send the I/D to an external server, so the server will use the I/D to select operations in the server. One parallel binary latch is written with a phone number that is to be dialed. A second binary latch is written with I/D that is sent to the dialed phone. This I/D can be used within the server in any way the server program chooses to use it, and is not further specified for courteousCellPhone systems. Finally the caller phone number should be automatically sent to the dialed phone. In a real estate presentation of a property, the phone number I/D that is sent from the cellPhone will call the real estate company's phone number, the data sent might have the number of the property being viewed, and the caller id phone number would be the cellPhone number to place a call to the cellPhone. Once such a cellPhone number is sent and the phone channel is set up, then without further operation by the courtesyCellPhone system, data will be exchanged between server and cellPhone according to the design of the server's program.

### Reliability and Equipment or Signal Loss.

Loss of communication, such as loss of signal due to the malicious user tampering with the ultrasonic signals, should reduce functionality from the cellPhone, as discussed now. Suppose a vehicle currently ignores finding the location of the cellPhone, checking only the cellPhone's speed. If any cellPhone moves faster than, say, 5 miles per hour, texting is disabled in it. Not only is a mobile vehicle driver unable to use his cellPhone for texting, which is desired, but also passengers other than the driver are unable to use cellPhones for texting. This is undesirable. If the cellPhone is upgraded to use the system described herein by overriding the disabling of texting if the cellPhone is not close to a driver, the driver still is unable to use his cellPhone for texting, as desired, but passengers can now use their cellPhone for texting, which is desirable. This system frees up the passenger's cellPhones to enable modules that previously would have become disabled.

The above handling of loss of communication is an instance of fail-safe operation. Loosing GPSS or courtesy signals or tampering with such signals converts the system described herein to the previous system, which is less desirable than the system described herein. The user would prefer to leave alone such signals instead of jamming, disconnecting, or disabling them.

When GPSS reception is lost, the present cellPhone system is unable to obtain the courteousCellPhone xyzCoordinate 103, which it needs to determine which zone the cellPhone is in, if any. A first effort in determining which modules are enabled/disabled is to continue to reuse the last good cellPhone xyzCoordinate 103 for a duration specified by Time 706. If that fails to provide useful xyzCoordinate 103 because of a timeout, then a second effort using an extended ZCBV 705 can be attempted, as described below.

In the second attempt to provide a useful xyzCoordinate, the server at least identifies which channel would have communicated a cellPhone's xyzCoordinate data to and from the one of the cellPhones, from and to the tower server. The server at least identifies which cellPhones communicate on the aforementioned channel. A bit vector is created by ORing each aforementioned cellPhone's ZCBV 705 into the vector. But if the two bits, setting and clearing the latch bit, thereby enabling or disabling a cellPhone's module, are 11 (trying to set and clear the latch bit), they are replaced by 00 and an error flag is set indicating an error. This value would be used by all cellPhones that are unable to get their own GPSS signal, and only by them.

The computed xyzCoordinate value may be outside the mobile vehicle, which is not usually credible. A failure, in capturing and using password or PIN number, is to generate from such a password or PIN an xyz-Coordinate that is outside the mobile vehicle so it is not credible. A small-range (pseudorandom number) PRN can be generated from the time of day returned from the GPSS, simultaneously in the ultrasonic signal transmitter and the ultrasonic signal receiver; PRN can be added to the pulse width in the transmitter and can be subtracted from the pulse width in the receiver. The signal can be repeated to ignore non-credible signals, to perform one operation, or multiple operations reduced to one operation.

In order to prevent theft of ultrasonic signal transmitters, a PGPSS transmitter used in a mobile vehicle can be given the mobile vehicle's VIN number, which would be stored in it. Thereafter upon restarting the vehicle, the mobile vehicle's VIN number would be sent to the cellPhone's PGPSS transmitter, to be compared with the stored VIN number. If they differ, some error message would be sent to the service provider to expose the improper use of the PGPSS receiver.

Note that, in the abovementioned system the cellPhone's service provider's or cellPhone's channel sends zone description from the server to the cellPhone. Alternatively, the cellPhone's server can use the GPSS xyzCoordinate which have just been sent from the cellPhone to the service provider's server, to calculate and transmit the ZCBV 705 to the cellPhone over the aforementioned channel.

### Final Remarks.

Applicant claims as his intellectual property any apparatus or method for supplying incorrect information to the conventional cellPhone 105, such as has been delineated in this specification or what one of ordinary skill in the art should be able to develop from it.

Applicant proposes a method where cellPhones incorporating the disabling and enabling operations can be learned in stages. Presently, cellPhones are widely used in mobile vehicles; any such cellPhone can be used as a basis of the design. The cellPhone is modified to incorporate an apparatus to determine if the cellPhone is going faster than some predetermined speed, or equivalent. In particular, the modification might be an app to run on a smart phone. Applicant has encountered advertisements for several such limited solution apparatuses; any such apparatus should be suitable for checking for speed and produce a signal which is received by the cellPhone's microcontroller, causing it to disable some cellPhone module's activity. This limited solution, for disabling modules when the vehicle is in motion as indicated by motion detector 307, should be implemented in, for instance, environments such as buses travelling on interstate highways. Some bus passengers might object to being unable to be texting while riding the bus. However, such kind of limited solution, disabling a cellPhone if moving faster than some predetermined speed, might be easy to sell and use. In fact this limited solution appears to be moving forward at the time of filing this application. Once the limited solution is accepted, the full solution, disabling driver's cellPhones but enabling passengers' cellPhones, should be easier to accept.

This invention enables passenger's cellPhones texting by overriding the system that disables texting when the cellPhone is moving at a high rate than a predetermined limit. This override mechanism utilizes a subsystem that determines where the driver is located in the bus. To prepare for using the apparatuses that determine the driver's position, the aforementioned ultrasonic courtesy signal buses could implement the vehicle's stereo wiring to speakers; the ultrasonic signals being sent to the speakers over the same wires that send audio to the speakers, or wires that are mechanically bundled up with the aforementioned audio wires. This wiring could be installed upon manufacturing the vehicle, making the vehicles “safeMobileTexting compliant”. “safeMobileTexting compliant” cellPhones could be rented, leased or sold along the roadway where the aforementioned buses travel. In fact, a free cellphone could be left in the bus so that bus riders who do not have the system described in this application can try out the cellphone, since the cellPhone is inoperable anywhere else than is enabled in the bus. Passengers that have use of the safeMobileTexting systems should be envied by the other passengers, who will want to rent, lease or own “safeMobileTexting compliant” cellPhones for themselves.

Incidentally, the PGCM 300 subsystem used in the cellphone, could be used in the field of robotics. Therein, once four transmitters are positioned in a space that is like the mobile vehicle's interior space, a set of robots can move about the aforementioned space, each robot getting its xyzCoordinates from the aforementioned PGCM 300 subsystem.

Applicant requests that claim 19 be considered for an early filing date (Oct. 2, 2007) because the application Ser. No. 11/865,810 has not yet issued (May 15, 2012). The claim is well-supported in the accompanying specification and figures[FIG. 14], and is the earliest reported claim for applications that can locate the driver of a mobile vehicle, to inhibit drivers texting but not inhibiting passengers texting.

Applicant requests that claim 20 be considered for an early filing date (Aug. 27, 1999) because U.S. Pat. No. 6,675,002 (ringing, an example of input to cellPhone) and U.S. Pat. No. 7,142,877 (transmitting rf, an example of output from the aforementioned cellPhone) were initially filed in a single combined application, but Examiner requested that Applicant divide the single application into two parts, a non-provisional utility application ('002) and a continuation ('877) thereof. In their original form of these applications, claim 1 illustrated a cellPhone input operation and an example of a cellPhone output operation, which together show that the applicant considered these to be members of the set having common ground of the two members, claiming the whole set rather than be limited to two specific cases thereof.

Modifications to this invention can be made by one skilled in the art without departing from the spirit of the invention. While the invention has been described in connection with illustrative embodiments, obvious variations therein will be apparent to those skilled in the art without the exercise of invention, accordingly the invention should be limited only to the scope of the appended claims.

I claim:

1. A system for enabling, disabling or restoring distracting operations in a cellPhone module in a mobile vehicle, comprising:
(a) a mobile vehicle operated by a driver who can steer or control the speed of said vehicle, said vehicle having a contiguous interior space wherein said driver is using a cellPhone,
(b) wherein at least one said cellPhone module can distract said mobile vehicle's driver,
(c) a finder that outputs xyzCoordinates of said cellPhone relative to said interior space,
(d) each cellPhone storing in a memory a nonempty set of zones, each zone comprised of a bit vector, a time duration, and a nonempty set of cuboids,
(e) wherein if said xyzCoordinate is within any said cuboid of any said zone, said zone's bit vector sets, clears or restores bits in said cellPhone modules for said time duration,
(f) said modifiable bits include at least one bit to enable or disable said distractive module's operation, wherein said module's operation does not distract said driver when it is disabled.

2. A system according to claim 1 in which said finder module is predominately a Global Positioning Satellite receiver that receives radio frequency signals from at least three radio frequency transmitters located in an earth satellite and outputs an xyzCoordinate of said receiver relative to said transmitters.

3. A system according to claim 2 in which said zone memory is in SRAM embedded in said cellPhone.

4. A system according to claim 3 in which said SRAM is operated as a virtual memory cache, backed up with mass memory located in a service provider's server, said server coupled through a service provider's channel through a cell tower to said SRAM.

5. A system according to claim 3 in which said SRAM is operated as a virtual memory cache, backed up with mass memory located in a server dedicated to operate the virtual memory, said server coupled through a dedicated channel through a cell tower to said SRAM.

6. A system according to claim 3 in which said SRAM is operated as a circular queue.

7. A system according to claim 1 in which said finder module receives ultrasonic signals from at least three ultrasonic transmitters located within said moving vehicle's contiguous interior, and outputs an xyzCoordinate relative to said transmitter.

8. A system according to claim 7 in which said finder module uses trilateration to compute said xyzCoordinate.

9. A system according to claim 7 in which finder module uses table lookup to compute said xyzCoordinate.

10. A system according to claim 1 in which mass memory is accessed through an embedded parallel processor to supply zone data to a checker module where said data is compared to said xyzCoordinate.

11. A system according to claim 10 in which said parallel processor is of MIMD type.

12. A system according to claim 10 in which said parallel processor is of MISD type.

13. A system according to claim 1 for locating a movable object in a long narrow space in which said finder module receives ultrasonic signals from at least tree ultrasonic transmitters each located at an end of a ladder's rung within said contiguous interior space and outputs an xyzCoordinate relative to said ultrasonic transmitters.

14. An apparatus comprising a contiguous space and a movable object in which said movable object's location can be determined relative to said contiguous space, comprising:
(a) said contiguous space in which a movable object can be located, said space having at least three ultrasonic transmitters, and having in it a movable object coupled to an ultrasonic receiver,
(b) a trilateration evaluator which is fed three ultrasonic signals from said ultrasonic receiver and which produces xyzCoordinates indicative of where said receiver is located.

15. A system according to claim 11, wherein if said cellPhone's xyzCoordinate is located in a predefined zone, a service provider's channel, simplex, half-duplex or full-duplex, is opened to communicate from within said cellPhone to another cellPhone.

16. A method for discouraging distractive driving wherein the moving vehicle driver eats while driving, comprising the steps of:
a. configuring a zone coextensive with a fast-food restaurant's drive-through lane,
b. repeating the following infinite loop of steps comprising:
i. driving a moving vehicle into said zone,
ii. said driver placing an order for a fast-food carryout meal and being served said meal,
iii. said moving vehicle leaving said zone,
iv. loading a cellPhone's memory location with an estimated time to eat the meal, said time being estimated automatically by said fast-food cash register, or manually by a fast-food waiter or waitress,
v. if the vehicle is stopped for said estimated time, or longer, send some indication or message to the driver, such as a text message, thanking him or her for stopping and eating said fast food,
vi. but if the moving vehicle does not stop after leaving the drive-through long enough for the driver to eat said meal, then send some indication or message to the driver, such as a text message, reminding him or her to stop and eat the fast food.

17. A system according to claim 1 which supplies incorrect information to the conventional cellPhone upon a plurality of receptions of said system's outputs.

18. A system according to claim 1 of application Ser. No. 11/865,810, filed Oct. 2, 2007, in which the delay of ultrasonic signals is used to determine whether a cellPhone is nearer to either of two ultrasonic transmitters disposed within a zone, as illustrated in FIG. 14 of said application.

19. A system according to claim 18, comprising two ultrasonic transmitters and an ultrasonic receiver in a mobile vehicle having a driver who has a cellPhone, wherein a first ultrasonic transmitter is near the driver and a second is kitty-corner in the zone to said first transmitter, in which said cellPhone's keyboard is disabled if said cellPhone is closer to said first transmitter than to said second transmitter, wherein disabled means that no more than a predetermined number of keys may be pressed within a predetermined time limit.

20. A system according to claim 1 of application Ser. No. 10/687,024, filed Oct. 16, 2003 now U.S. Pat. No. 7,142,877, which is a continuation of application Ser. No. 09/384,723, filed Aug. 27, 1999 now U.S. Pat. No. 6,675,002, in which said control signal is ultrasonic, and in which said muting means that no more than a predetermined number of keys may be pressed within a predetermined time limit.
